(19) United States
(12) Patent Application Publication
(10) Pub. No.: US 2005/0006832 A1
(43) Pub. Date: Jan. 13, 2005

(54) Torque limiter and automatic open close unit for toilet seat and seat cover using the same

(76) Inventors: Kazuki Hoshi, Nagano (JP); Kazunori Nishikawa, Nagnao (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/846,391

(22) Filed: May 13, 2004

(30) Foreign Application Priority Data
May 14, 2003 (JP) 2003-135415

(51) Int. Cl. F16F 1/14

(52) U.S. Cl. 267/154

(57) ABSTRACT

The present invention provides a torque limiter with an easy maintenance feature. It is capable of alignment and bidirectional rotation. The present invention overcomes the problems of torque limiters of conventional technology by providing a torque limiter comprising an inner ring and an outer ring wherein when a torque is applied to an input member, which is inner ring or outer ring, is less than a set torque, the inner ring and the outer ring move in response to each other. Stopper grooves are provided on inner ring or outer ring and a flat spring is provided on inner ring or outer ring such that it pushes roller pins against stopper grooves; wherein when the torque applied to roller pins exceeds a set torque, roller pins cause flat spring to elastically deform such that roller pins come out of stopper grooves. Inner ring and outer ring are thus uncoupled.

### CROSS-REFERENCE TO RELATED APPLICATIONS

This application claims priority of Japanese Application No. 2003-135415, filed May 14, 2003, the complete disclosure of which is hereby incorporated by reference.

### BACKGROUND OF THE INVENTION

a) Field of the Invention

The present invention relates to a torque limiter which does not output a torque if an input torque is less than a set torque but outputs a torque equal to the input torque if the input torque exceeds the set torque. It also relates to an automatic open/close unit for a toilet seat and a seat cover utilizing the torque limiter. More specifically, the present invention relates to a torque limiter which takes advantage of an elastic force derived from a spring and an automatic open/close unit for a toilet seat and a seat cover utilizing the torque limiter.

b) Description of the Related Art

There is a type of a torque limiter which moves an input member and output member in response to each other causing friction therebetween. If a torque applied to the input member exceeds a given friction, the output member is caused to slip, thereby preventing the responsive motions to occur between the input member and output member. Another type of torque limiter utilizes high viscid oil between an input member and output member.

Another type of torque limiter utilizes a one-way clutch in which a torsional spring or a needle bearing is provided in the joint between two shafts, for example, such that a motion of only one shaft does not induce a responsive motion in the two shafts. However, the two torques generated in opposite directions cause one shaft to touch the other shaft via a torsional spring or needle, allowing the two shafts to rotate in response to each other. The one way-clutch thus works as a torque limiter.

### PROBLEMS THE INVENTION INTENDS TO SOLVE

Nonetheless, the type of torque limiter utilizing friction between two components as described above provides poor durability and must be maintained frequently, requiring elaborate management efforts. Another type of torque limiter utilizes oil; however, viscosity of oil is susceptible to temperature changes. This limits the conditions for its use, and requires elaborate efforts for changing friction settings and maintaining good conditions thereof.

There is yet another type of torque limiter utilizing a one-way clutch, which means that the torque limiter works only in one direction of rotation. This type does not provide a bidirectional torque limiter. To provide bidirectional torque limiters in torque limiters of this type, one must prepare two one-way clutches or install a complex mechanism, necessitating the need for a large sized system and higher costs.

None of the above torque limiters considers alignment of an input member and an output member. Therefore, to align these members, an aligner must be provided in the torque limiter.

### OBJECT AND SUMMARY OF THE INVENTION

To overcome the previously described problems, the primary object of the present invention is to provide a torque limiter which is easy-to-manage, rotatable in two directions and capable of alignment. It also provides an automatic open/close unit for a toilet seat and a seat cover utilizing such a torque limiter.

In accordance with the present invention, the problems previously described are overcome by providing a torque limiter comprising an inner ring and an outer ring wherein if a torque is applied to an input member, a first ring, which is either the inner ring or the outer ring, is less than a set torque, the inner ring and the outer ring move in response to each other. The torque limiter further comprises: stopper grooves on the first ring or the outer ring; and a flat spring provided on the second ring, the inner ring or the outer ring without the stopper grooves, such that the flat spring pushes stopper members against the stopper grooves such that the stopper members are caught by the stopper grooves. If a torque applied to the input member exceeds a set torque, the stopper members cause the flat spring to elastically deform such that the stopper members come out of the stopper grooves, thereby uncoupling the inner ring and the outer ring.

The present invention switches the transmitting state and the non-transmitting state of a force applied by a flat spring. The torque limiter of the present invention thus provides better durability than that of conventional technology because it causes little abrasion between the components. It is more resistant to temperature changes than a torque limiter of conventional technology utilizing viscosity of oil for its operation.

Moreover, even though the torque limiter of the present invention is built with fewer components than a torque limiter of conventional technology, it can be used as a bidirectional torque limiter. It functions as a torque limiter when stopper members are caught by stopper grooves, thereby aligning an inner ring and an outer ring.

It is desirable that the torque limiter of the present invention provide an engagement portion on the other ring, which is the inner ring or the outer ring without the stopper grooves; wherein the stopper members are roller pins which are meshed with the stopper grooves and the engagement portion. If a torque applied to the input member exceeds the set torque, the roller pins cause the flat spring to elastically deform such that the roller pins come out of the stopper grooves, thereby uncoupling the inner ring and the outer ring. The use of roller pins, which generally have the kind of rigidity required for stopper members, ensures the presence of responsive motions between the inner ring and the outer ring if the input torque is less than the set torque. Also, the use of roller pins reduces friction between the roller pin and a stopper groove. Roller pins ensure the presence of a torque limiting function if an input torque exceeds a set torque.

It is also desirable that the stopper members are stopper convex portions provided on the flat spring in the present invention. The number of components required for the torque limiter assembly is thus reduced while simplifying the configuration thereof.

The torque limiter of the present invention can also be used in an automatic open/close unit for a toilet seat and a seat cover which opens and closes the toilet seat and the seat cover by transmitting the torque generated by a motor. It is applied to a portion where the motor, the toilet seat, and the seat cover are joined together.

In this case, torque limiters show little abrasion, thereby enhancing the lifetime of the automatic open/close unit thereof requiring less frequent maintenance. It is also temperature resistant, thereby providing an automatic open/close unit that can be used under a wider variety of conditions.

The configuration of the present invention is described herein with reference to embodiments illustrated in the drawings.

### BRIEF DESCRIPTION OF THE DRAWINGS

In the drawings:

FIG. 1 is a diagram illustrating the torque limiter of the present invention;

FIG. 1(A) is a top view illustrating the torque limiter with a section at A-A.

FIG. (B) is a front view illustrating the torque limiter of FIG. 1(A) with a section at B-B;

FIG. 2 is a diagram illustrating the torque limiter being disassembled;

FIG. 2(A) is the torque limiter viewed from above.

FIG. 2(B) is the torque limiter viewed from below;

FIG. 3 is a diagram illustrating the automatic open/close unit for a toilet seat and a seat cover being disassembled for a view from above;

FIG. 4 is a diagram illustrating the automatic open/close unit for a toilet seat and a seat cover being disassembled with a view from below; and

FIG. 5 is a cross sectional top view of the torque limiter according to another embodiment.

### DESCRIPTION OF THE PREFERRED EMBODIMENTS

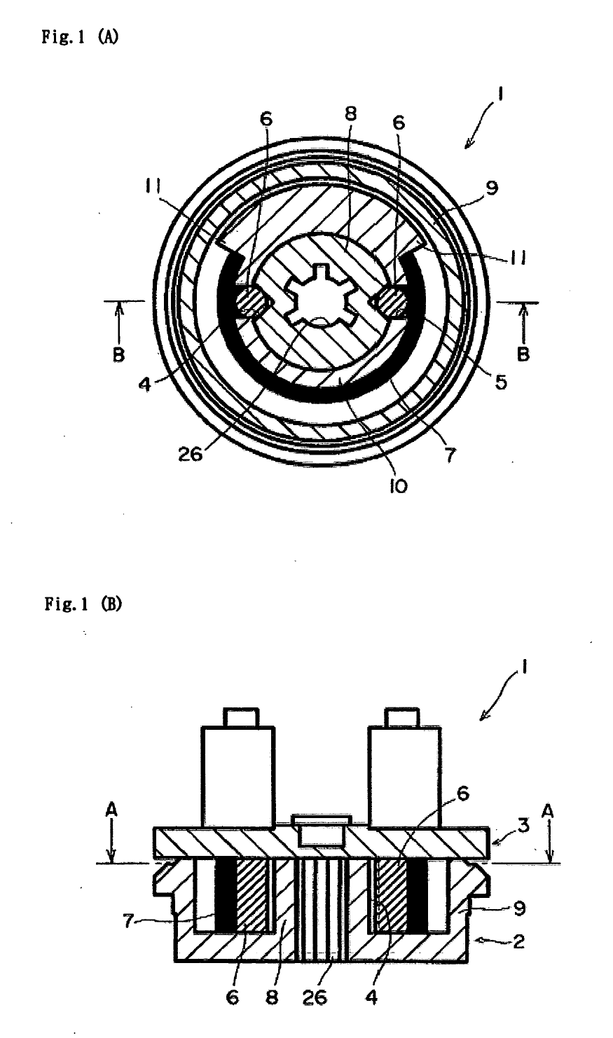

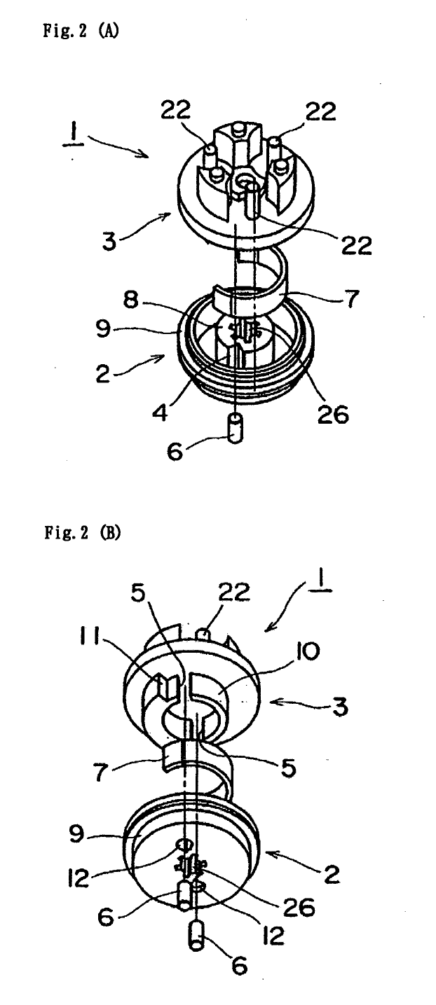

FIGS. 1 and 2 illustrate an embodiment of the torque limiter (1) of the present invention. Torque limiter (1) comprises an inner ring (2); and an outer ring (3). If a torque applied to an input member, which is a first ring selected from inner ring (2) or outer ring (3), is less than a set torque, the inner ring (2) and the outer ring (3) move in response to each other. Torque limiter (1) further comprises: stopper grooves (4) on the first ring; and a flat spring (7) provided on a second ring, which is inner ring (2) or outer ring (3) without the stopper grooves, such that flat spring (7) pushes the stopper members against stopper grooves (4) to let the stopper members be caught by the stopper grooves (4). Particularly in this embodiment, engagement portions (5) are provided at the second ring, which is inner ring (2) or outer ring (3) without the stopper grooves and stopper members are roller pins (6) that are to be caught by stopper grooves (4) and engagement portions (5). If a torque applied to the input member exceeds a set torque, stopper members cause flat spring (7) to elastically deform such that roller pins (6) come out of stopper grooves (4). Inner ring (2) and outer ring (3) are thus uncoupled.

Inner ring (2) comprises: a boss portion (8) and an outer wall portion (9). Outer ring (3) has a meshing wall portion (10) which rotatably meshes with boss portion (8) of inner ring (2). Meshing wall portion (10) of outer ring (3) meshes with boss portion (8), thereby connecting inner ring (2) and outer ring (3) in a rotatable manner. Engagement portions (5) are provided at two places 180 degrees apart on the outer circumference of boss portion (8) by cutting two places on meshing wall portion (10). Stopper grooves (4) are provided at two places on boss portion (8) of inner ring (2) 180 degrees apart on the outer circumference of boss portion (8) by cutting. For this reason, inner ring (2) and outer ring (3) are aligned every 180 degrees to be fixed thereon. Note that stopper grooves (4) are given a triangular cross section through the axis to reduce friction between the outer circumferences of roller pins (6) and stopper grooves (4).

Flat spring (7) is circular in shape with an angle of over 180 degrees. Flat spring (7) meshes with the outside of meshing wall portion (10) of outer ring (3) so as to cover each engagement portion (5). Flat spring (7) is an arc of more than 180 degrees, which can cover two engagement portions (5) at the same time. Stopper (11) which prevents rotation of flat spring (7) is provided at a place where meshing wall portion (10) does not mesh with flat spring (7).

Roller pins (6) are provided inside each engagement portion (5) and are energized toward the inside of flat spring (7). In FIG. 2, Reference Numeral (12) is a through hole, which allows insertion of roller pins (6) from the outside to the inside inner ring (2).

An example of the operation of the aforementioned torque limiter (1) is described below.

When roller pins (6) are caught by stopper grooves (4), as illustrated in FIG. 1, boss portion (8) of inner ring (2) and meshing wall portion (10) of outer ring (3) are coupled via roller pins (6) causing inner ring (2) and outer ring (3) to be aligned and rotate in response to each other. If a large torque is applied to a point between inner ring (2) and outer ring (3), edges of stopper grooves (4) push roller pins (6) against flat spring (7) toward the outside until they push roller pins (6) out of stopper grooves (4). Inner ring (2) and outer ring (3) thus enter an idling (non responsive) mode.

As the torque diminishes, roller pin (6) is caught by stopper groove (4). Inner ring (2) and outer ring (3) thus are aligned together again to rotate in response to each other.

An embodiment utilizing torque limiter (1) in an automatic open/close unit (13) for a toilet seat and a seat cover are described herein.

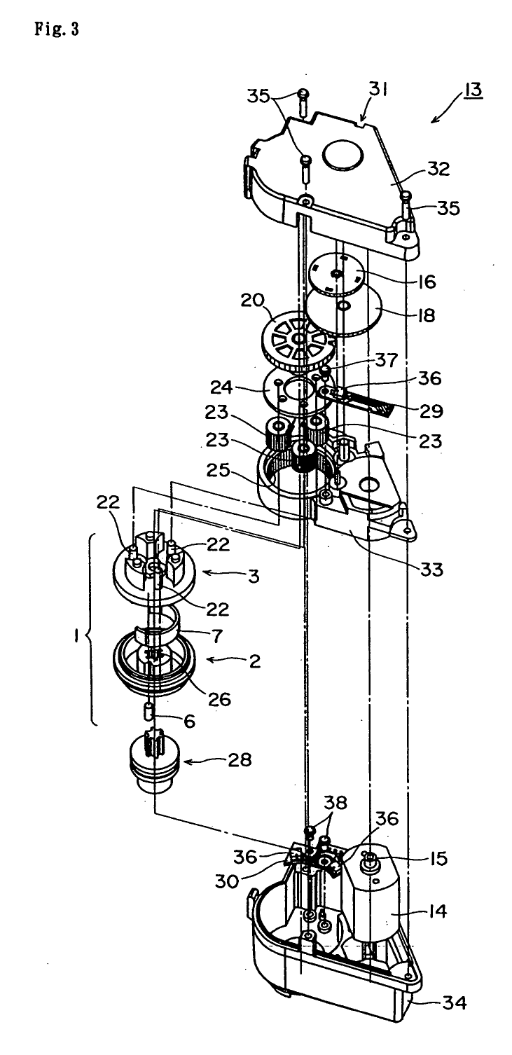

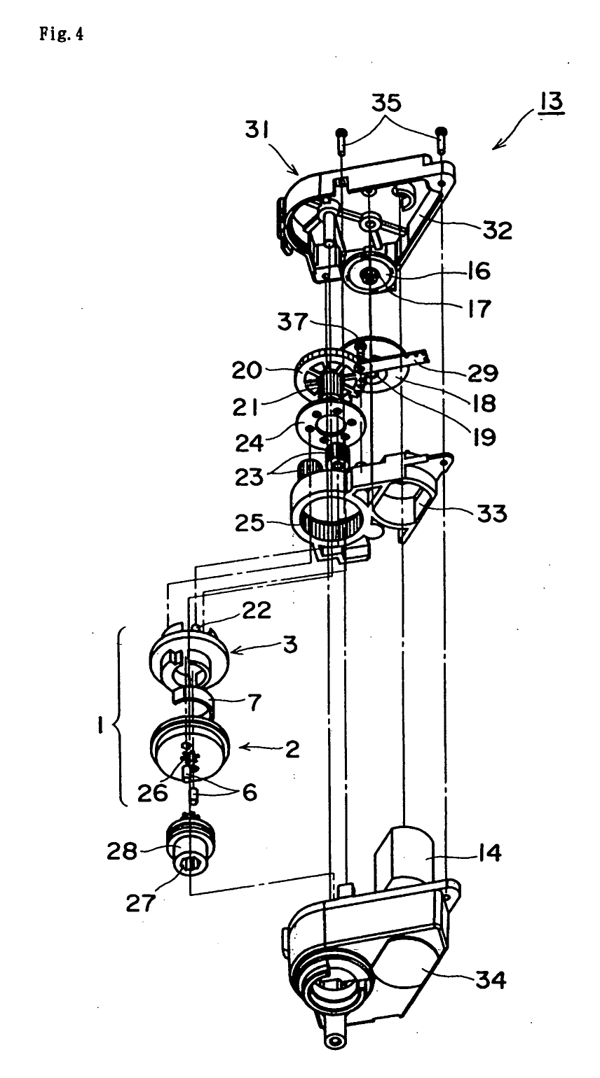

FIGS. 3 and 4 illustrate an embodiment of the automatic open/close unit (13) for a toilet seat and a seat cover of the present invention. Automatic open/close unit (13) opens and closes a toilet seat or a seat cover by transmitting power from motor (14) thereto. The above torque limiter (1) is applied to a joint between motor (14) and a toilet seat with a seat cover.

Automatic open/close unit (13) comprises: a motor (14); a pinion (15) provided on the shaft of motor (14); a first gear (16) to be meshed with pinion (15); a first pinion (17) integrally formed with the shaft of first gear (16); a second gear (18) to be meshed with first pinion (17); a second pinion (19) formed integral with the shaft of second gear (18); a third gear (20) to be meshed with second pinion (19); a third pinion (21) integrally formed with the shaft of third gear (20); three support shafts (22) formed on outer ring (3) of torque limiter (1); planet gears (23) which are rotatable around each support shaft (22) while being meshed with third pinion (21); a lid (24) which secures planet gears (23) with support shafts (22); an internal gear (25) which surrounds planet gears (23); a splined mount hole (26) provided on boss portion (8) of inner ring (2) in torque limiter (1); hinge pin receiver (28) having a receiving hole (27) to receive a hinge pin on the toilet seat or seat cover while being secured onto mount hole (26) by insertion; outer ring end sensor board (29) which detects the number of rotations at the outer ring (3) end; inner ring end sensor board (30) which detects the number of rotations at the inner ring (2) end; and a casing (31) which houses all of the above components.

Only one of the seat cover and the seat is attached to automatic open/close unit (13). To automatically open and close both the seat cover and the toilet seat, one should use two automatic open/close units (13). Here, the input member for torque limiter (1) is outer ring (3).

Casing (31) comprises: an upper casing (32); a middle casing (33); and a lower casing (34). Each casing (32), (33), and (34) is screwed with bolt (35). Middle casing (33) and inner gear (25) are integrally formed. The number of components required for building automatic open/close unit (13) is thus economized.

Each sensor board (29), (30) detects the magnet attached to rotating members utilizing Hall IC (36) as the magnet passes sensor board (29), (30) to further detect the angle of rotation of the rotating member. Sensor board (29) provided at the outer ring end is secured onto middle casing (33) by bolt (37) and detects the magnet attached to first gear (16) as it passes sensor board (29) to further detect the number of rotations of first gear (16). In addition, sensor board (30) provided at the inner ring end is secured onto lower casing (34) by bolt (38) and detects the magnet attached to inner ring (2) as it passes sensor board (30) to further detect the rotation angle of the toilet seat or the seat cover.

Operation of automatic open/close unit (13) for the toilet seat and the seat cover described above is described herein.

Automatic open/close unit (13) is installed on a toilet. Then, a hinge pin of a toilet seat or seat cover is secured onto hinge pin receiver (28). Motor (14) starts to rotate outer ring (3) of torque limiter (1) via first gear (16)→first pinion (17), second gear (18)→second pinion (19)→third gear (20)→third pinion (21)→planet gear (23). This torque is transmitted from inner ring (2) of torque limiter (1) to the toilet seat or toilet cover via hinge pin receiver (28).

During the sequence of motions, sensor board (29) at the outer ring end detects the number of rotations of first gear (16), which tells whether motor (14) is operating normally. Sensor board (30) at the inner ring end detects the rotation angle of inner ring (2), which indicates the open or closed state of the toilet seat or seat cover.

According to this embodiment, the presence of torque limiter (1) between motor (14) and the seat cover or a toilet seat prevents a gear from chipping even though an excessive torque is applied thereto. Additionally, torque limiter (1) is more friction resistant than a torque limiter of conventional technology, therefore, it lasts longer and requires less frequent maintenance than a limiter conventional technology. Moreover, torque limiter (1) of this embodiment is more temperature resistant than a torque limiter of conventional technology, therefore, the automatic open/close unit (13) of this embodiment finds wider applications than a torque limiter of conventional technology.

Further according to this embodiment, torque limiter (1) is aligned every time it rotates 180 degrees while the toilet seat cover rotates about 120 degrees. This means that, even though a toilet seat or a seat cover is forcefully rotated, torque limiter (1) is always aligned at a constant angle.

The above embodiment is an example of the desirable mode of the present invention. However, the present invention is not limit to this embodiment. The present invention may be modified in many ways as long as the spirit of the present invention remains the same. For example, in the above embodiment, stopper groove (4), engagement portion (5), and flat spring (7) are arranged from the inside in that order and flat spring (7) pushes roller pins (6) into the inside of torque limiter (1). However, stopper grooves (4), engagement portion (5), and flat spring (7) may be arranged from the outside in that order such that flat spring (7) pushes roller pins (6) toward the outside. Flat spring (7) is circularly shaped in the above embodiment; however, it may have a linear or cylindrical shape.

Also in the above embodiment, stopper groove (4) and engagement portion (5) are provided at two places. However, they may be provided at one place or more than three places. Different numbers of stopper grooves (4) and engagement portions (5) may be used. The number of roller pins (6) is not limited to two. It may be any number as long as it is less than 5.

Further, in the above embodiment, stopper grooves (4) are provided on inner ring (2) and engagement portions (5) are provided on outer ring (3). However, engagement portion (5) may be provided on inner ring (2) and stopper groove (4) may be provided on outer ring (3).

Through hole (12) is provided on inner ring (2) in the above embodiment. However, it may be eliminated and roller pins (6) may be directly provided on stopper grooves (4) through the opening end of inner ring (2).

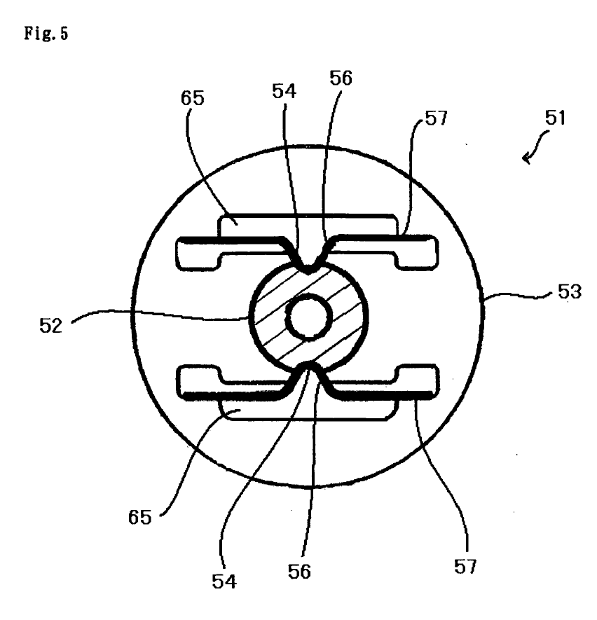

In the above embodiment, roller pins (6) work as stopper members being caught by stopper grooves (4) and engagement portions (5). However, stopper members are not limited to roller pins (6). In other words, any spherical joint member may be used in place of roller pins (6). Alternatively, stopper members may be stopper convex portions (56) provided on flat spring (57) as illustrated in FIG. 5. Torque limiter (51) illustrated in FIG. 5 is described more specifically herein.

Torque limiter (51) has an inner ring (52) and an outer ring (53). Inner ring (52) and outer ring (53) move in response to each other only if the torque applied to an input member, inner ring (52) or outer ring (53), is less than a set torque. In this torque limiter (51), stopper grooves (54) are provided on inner ring (42); two flat springs (57) are provided on outer ring (53) wherein the two flat springs (57) push stopper members into stopper grooves (54) to be caught therein. In this embodiment, stopper members are stopper convex portions (56) provided on flat spring (57). If a torque applied to the input member exceeds a set torque, stopper convex portions (56) cause flat spring (57) to elastically deform such that stopper convex portions (56) come out of stopper grooves (54). Inner ring (52) and outer ring (53) are thus uncoupled.

Stopper grooves (54) are provided at two places that are 180 degrees apart on the outer circumference of inner ring (52). Concave portions (65) having flat spring (57) are formed at two places that are 180 degrees apart. In addition, stopper convex portions (56) are integral with flat spring (57) because they are formed by bending flat spring (57). When flat spring (57) is attached to concave portions (65), stopper convex portions (56) are pushed toward stopper grooves (54).

Torque limiter (51) thus configured can operate in the same manner as torque limiter (1). It can also be applied to automatic open/close unit (13) for a toilet seat and a seat cover.

Stopper grooves may be provided on outer ring (53) and flat spring (57) on the inner ring (52) in the mode illustrated in FIG. 5 as well. The number of stopper grooves (54) and spring (57) is not limited to two and may be more than three. The number of stopper grooves (54) may be different from that of flat spring (57).

As described above, the torque limiter of the present invention switches the transmitting state and the non-transmitting state of an elastic force derived from a flat spring. The torque limiter of the present invention thus provides better durability than that a torque limiter of conventional technology by reducing abrasion amongst components. It is more resistant to temperature than a torque limiter of conventional technology; therefore, it can be used in a wider variety of conditions.

Further, even though the torque limiter of the present invention is built with fewer components than a torque limiter of conventional technology, it can be used as a bidirectional torque limiter. Stopper members trigger its torque limiter function when they are caught by stopper grooves, automatically aligning the inner ring and the outer ring.

According to the automatic open/close unit for a toilet seat and a toilet cover of the present invention, the torque limiter shows little abrasion, thereby enhancing the lifetime of the automatic open/close unit thereof and requires less frequent maintenance. It is also temperature resistant, which allows an automatic open/close unit to be used under a wider variety of conditions.

While the foregoing description and drawings represent the present invention, it will be obvious to those skilled in the art that various changes may be made therein without departing from the true spirit and scope of the present invention.

### DESCRIPTION OF REFERENCE SYMBOLS

1 torque limiter
2 inner ring
3 outer ring
4 stopper groove
5 engagement portion
6 roller pin (stopper member)
7 flat spring
13 automatic open/close unit for toilet seat and toilet cover
51 torque limiter
52 inner ring
53 outer ring
54 stopper groove
56 stopper convex portion (stopper member)
57 flat spring

1. A torque limiter comprising:
an inner ring;
an outer ring;
an input member, wherein if torque applied to said input member, a first ring which is either said inner ring or said outer ring, is less than a set torque, said inner ring and said outer ring moving in response to each other;
said torque limiter further comprising stopper grooves on said first ring and a flat spring provided on a second ring, which is said inner ring or said outer ring without said stopper grooves, such that said flat spring pushes stopper members against said stopper grooves so that said stopper members are caught by said stopper grooves;
wherein if torque applied to said input member exceeds said set torque, said stopper members cause said flat spring to elastically deform such that said stopper members come out of said stopper grooves, thereby uncoupling said inner ring and said outer ring.

2. The torque limiter as set forth in claim 1 which provides an engagement portion on said second ring, which is said inner ring or said outer ring without said stopper grooves; wherein said stopper members are roller pins which are caught by said stopper grooves and said engagement portion; when a torque applied to said input member exceeds said set torque, said roller pins cause said flat spring to elastically deform such that said roller pins come out of said stopper grooves, thereby uncoupling said inner ring and said outer ring.

3. The torque limiter as set forth in claim 1 wherein said stopper members are stopper convex portions provided on said flat spring.

4. An automatic open/close unit for a toilet seat and a seat cover which opens and closes said toilet seat and said seat cover by transmitting the torque generated by a motor and utilizes said torque limiter of claim 1 at a portion where said motor, said toilet seat, and said seat cover are joined together.

5. An automatic open/close unit for a toilet seat and a seat cover which opens and closes said toilet seat and said seat cover by transmitting the torque generated by a motor and utilizes said torque limiter of claim 2 at a portion where said motor, said toilet seat, and said seat cover are joined together.

6. An automatic open/close unit for a toilet seat and a seat cover which opens and closes said toilet seat and said seat cover by transmitting the torque generated by a motor and utilizes said torque limiter of claim 3 at a portion where said motor, said toilet seat, and said seat cover are joined together.
